(19) United States
(12) Patent Application Publication
(10) Pub. No.: US 2026/0014788 A1
(43) Pub. Date: Jan. 15, 2026

(54) PROCESS IMPROVING ADHESION BETWEEN KETONE ETHYLENE ESTER/POLYVYNIL CHLORIDE ROOF MEMBRANES AND RUBBERIZED TAPE

(71) Applicant: JOHNS MANVILLE, DENVER, CO (US)

(72) Inventors: Jordan Kortmeyer, Parker, CO (US); William Sanborn, Denver, CO (US); Diego Pedrazzoli, Littleton, CO (US); Jonas Houchin, Centennial, CO (US)

(21) Appl. No.: 19/238,004

(22) Filed: Jun. 13, 2025

Related U.S. Application Data
(60) Provisional application No. 63/669,727, filed on Jul. 11, 2024.

(51) Int. Cl. B32B 37/12; B32B 7/12; B32B 25/08; E04D 5/06; E04D 5/14; E04G 23/02

(52) U.S. Cl. CPC B32B 37/1284; B32B 7/12; B32B 25/08; E04D 5/06; E04D 5/148; E04G 23/0281; B32B 2305/70; B32B 2419/06

(57) ABSTRACT

A novel process for ensuring adequate adhesion between a ketone ethylene ether (KEE) and liquid polyvinyl chloride (PVC) roofing membrane and rubberized tape. The process can be used for roofing membrane repair, maintenance, and reinforcement. The present process uses a plasticizer primer comprising phthalate to coat the KEE/PVC roofing membrane, which has been shown to improve the adhesion to rubberized tape, allowing for good adhesion and increasing the lifespan of the repair, maintenance, and reinforcements.

### TECHNICAL FIELD

This disclosure relates to a process which ensures adequate adhesion between a ketone ethylene ether and liquid polyvinyl chloride roofing membrane and rubberized tape.

### BACKGROUND

Polyvinyl chloride is the third most widely produced synthetic polymer of plastic in the entire world. Every year, roughly forty million tons of PVC are produced. Used in countless applications, PVC is used to make drainage pipes, window frames, medical devices, stationery, fashion and footwear, automotive interiors, and roofing membranes.

PVC roofing membranes are a single-ply solution that can be used for both commercial structures and, in some cases, residential homes. Single-ply membranes are sheets of synthetic materials that can be chemically adhered or ballasted to insulation to provide a layer of protection. Sometimes composed of two layers of PVC with polyester material in between for additional reinforcement, PVC membranes can be chemically treated to impart resistance to bacteria, heat, fats, oil, UV exposure.

PVC is particularly well suited for low slope applications, and as such is often used on commercial and industrial buildings. These buildings have roofs with large surface areas, making routine maintenance and repairs to the PVC roofing difficult. Due to the single ply nature of PVC roofing membranes, holes must be cut through the membrane to accommodate protruding elements such as chimneys, introducing potential areas for water to leak through and damage the roof and adding to the complexity of installation. Thus, when modifications, maintenance, and repairs are completed, it desirable both from a cost and labor perspective that the work completed is long lasting and effective.

One method commonly used for modifications, maintenance, and repairs comprises adhering smaller patches of PVC to the pre-existing roofing surface using rubberized tape. This method allows damaged areas, as well as areas around protruding elements, to be directly and effectively addressed. However, exposure to heat and some forces, such as maintenance workers walking over patched surfaces, can compromise and unduly strain the adhesion between the roofing membrane and PVC patches. This problem can be further compounded by modern compositions of PVC roofing materials, such as those which comprise ketone ethylene ester (KEE).

KEE is a PVC roofing additive that helps extend the lifespan of PVC roofs through its temperature tolerance and microorganism (mold) growth prevention properties. Despite these benefits, PVC roofing membranes comprising KEE as an additive offer a worrying low amount of adhesion, especially to traditional methods of attachment such as rubberized tape. Due to the benefits of using KEE as an additive in PVC roofing membranes as well as rubberized tape to facilitate targeted modification, maintenance, and repair of said membrane, a novel and efficient method for increasing the adhesion between a KEE/PVC roofing membrane and rubberized tape would be of great interest to the industry.

### SUMMARY

Against this backdrop the present invention was developed. Presented is a novel process offering a new efficient method of ensuring adequate adhesion between a ketone ethylene ether (KEE) and liquid plasticized polyvinyl chloride (PVC) roofing membrane and rubberized tape. The process employs a novel plasticizer primer comprising a phthalate.

In one embodiment, areas where damage has occurred to a roof can be repaired using KEE/PVC roofing patches, plasticizer primer comprising phthalate, and rubberized tape. In one embodiment the plasticizer primer comprises a phthalate. In various embodiments the phthalate may comprise diisodecyl phthalate (DIDP), diisononyl phthalate (DINP), dinoctyl phthalate (DNOP), diundecyl phthalate (DUP), or other phthalates. Surprisingly, it has been shown that rubberized tape, when adhered to a KEE/PVC roofing membrane, treated with the present primer comprising phthalate, and placed under strain, will fail structurally before losing adhesion to the roofing membrane. This demonstrates the efficacy of the adhesive properties imparted by the present process when using a plasticized primer comprising phthalate, which is beneficial to the industry.

In one embodiment, elements protruding through a roofing membrane, such as a chimney, can be reinforced using KEE/PVC roofing membranes, plasticizer primer comprising phthalate, and rubberized tape. Reinforcing the areas surrounding these protruding elements can increase the water resistance of the roof.

In one embodiment, seams between roofing membrane sections can be reinforced using KEE/PVC roofing membranes, plasticized primer comprising phthalate, and rubberized tape. Reinforcing seems between roofing membranes using this process can increase the water resistance of the roof. In one embodiment sealing seams between roofing membranes can be accomplished using a KEE/PVC roofing membrane patch, a large patch of rubberized tape, and plasticizer primer comprising phthalate. In another embodiment sealing seams between roofing membranes can be accomplished using a KEE/PVC roofing membrane patch, two strips of rubberized tape on either side of the seam, and plasticizer primer comprising phthalate. This embodiment conserves material allowing for efficient and economic reinforcement of seams between roofing membranes.

The present process offers a new efficient method of ensuring adequate adhesion between a ketone ethylene ether (KEE) and liquid plasticized polyvinyl chloride (PVC) roofing membrane and rubberized tape.

### BRIEF DESCRIPTION OF THE DRAWINGS

FIG. 1 depicts a process of adhering a roofing patch to a damaged roof using rubberized tape, without the presence of plasticized primer.

FIG. 2 depicts an adhesive failure between rubberized tape and a ketone ethylene ether/polyvinyl chloride roofing membrane when using a typical PVC plasticized primer.

FIG. 3 depicts one embodiment of the present process of adhering a roofing patch to a damaged roof using rubberized tape and plasticizer primer comprising phthalate.

FIG. 4 depicts rubberized tape splitting while remaining adhered to the ketone ethylene ether/polyvinyl chloride roofing membrane treated with the present primer composition comprising phthalate.

FIG. 5 depicts one embodiment of adhering a roofing patch around an element protruding from a roof using rubberized tape and plasticizer primer comprising phthalate.

FIG. 6 depicts one embodiment of adhering a roofing patch over a roofing seam using one piece of rubberized tape and plasticizer primer comprising phthalate.

FIG. 7 depicts one embodiment of adhering a roofing patch over a roofing seam using a plurality of pieces of rubberized tape and plasticizer primer comprising phthalate.

### DETAILED DESCRIPTION

Before the present process ensuring the adequate adhesion between a ketone ethylene ether (KEE) and liquid polyvinyl chloride (PVC) roofing membrane and rubberized tape is disclosed and described, it is to be understood that this disclosure is not limited to the particular structures, process steps, or materials disclosed herein, but is extended to equivalents thereof as would be recognized by those ordinarily skilled in the relevant arts. It should also be understood that terminology employed herein is used for the purpose of describing particular embodiments only and is not intended to be limiting. It must be noted that, as used in this specification, the singular forms “a,” “an,” and “the” include plural referents unless the context clearly dictates otherwise. Thus, for example, reference to “a step” may include multiple steps, reference to “producing” or “products” of a reaction or treatment should not be taken to be all of the products of a reaction/treatment, and reference to “treating” may include reference to one or more of such treatment steps. As such, the step of treating can include multiple or repeated treatment of similar materials/streams to produce identified treatment products.

Numerical values with “about” include typical experimental variances. As used herein, the term “about” means within a statistically meaningful range of a value, such as a stated particle size, concentration range, time frame, molecular weight, temperature, or pH. Such a range can be within an order of magnitude, typically within 10%, and more typically within 5% of the indicated value or range. Sometimes, such a range can be within the experimental error typical of standard methods used for the measurement and/or determination of a given value or range. The allowable variation encompassed by the term “about” will depend upon the particular system under study, and can be readily appreciated by one of ordinary skill in the art. Whenever a range is recited within this application, every whole number integer within the range is also contemplated as an embodiment of the invention.

This invention discloses a process ensuring adequate adhesion between a ketone ethylene ether (KEE) and liquid plasticized polyvinyl chloride (PVC) roofing membrane and rubberized tape. If adequately adhered, rubberized tape can be used as an economic and versatile method of roofing repair, reinforcement, or maintenance. However, adhesive failures can compromise the water resistance of roofing membranes, thereby decreasing the effectiveness and lifespan of the roofing membrane, and potentially causing damage to the underlying structure. Water damage to the underlying structure can cost thousands to tens of thousands of dollars. Thus, adequate adhesion between roofing membranes, patches, and rubberized tape is extremely desirable.

Central to the present process of ensuring adequate adhesion between roofing membranes, patches, and rubberized tape is the use of a plasticizer primer composition comprising phthalate. Use of the present primer comprising phthalate increases the adhesion between rubberized tapes and KEE/PVC roofing membranes. Typical PVC plasticizer primers are known and comprise components such as toluene, heptane, isophorondiamine, dibutyltin dilaurate, and isophonone, but not phthalate. However, it has been discovered that the addition of a phthalate surprisingly increases the adhesive properties of typical plasticizer primers. In one embodiment, the use of a PVC plasticizer primer comprising phthalate can be especially effective in improving the adhesion of rubberized tape to KEE/PVC roofing membranes. In various embodiments the phthalate can be diisodecyl phthalate (DIDP), diisononyl phthalate (DINP), di-n-octyl phthalate (DNOP), diundecyl phthalate (DUP), or any other suitable phthalate. A mixture of phthalates can also be used.

In one embodiment, the plasticizer primer can comprise 50-90 vol % toluene, 4-9 vol % heptane, 0.009-0.09 vol % isophorondiamine, less than 0.09 vol % dibutyltin dilaurate, and 0.009-0.09 vol % isophonone diisocyanate and 0.5-20 vol % phthalate. In one embodiment the concentration of phthalate in the plasticizer primer can be in the range of from about 5-15 vol %. In another embodiment the concentration of phthalate in the plasticizer primer can be in the range of from about 7-13 vol %. In another embodiment, the concentration of phthalate can range from 10-15 vol %.

In one embodiment the rubberized tape adhesion can be improved with other primers and activators. In one embodiment the plasticized primer can be used with a conventional KEE/PVC roofing membrane comprising 10-30 vol % KEE plasticizer. Use of the present primer comprising phthalate in conjunction with the roofing membrane in this embodiment has been shown to be particularly desirable. Using an adhesion promoter such as the present plasticizer primer along with a KEE/PVC roofing membrane can prevent rubberized tape from losing adhesion overtime. If rubberized tape loses adhesion overtime the water resistance of the roof assembly can decrease and allow water to enter the building that is being protected by a PVC roofing membrane. Thus, it is extremely desirable to ensure adequate adhesion between rubberized tape and a KEE/PVC roofing membrane.

In one embodiment roofing patches can be cut from a KEE/PVC roofing membrane. In one embodiment roofing patches can be cut from a fresh roll of KEE/PVC roofing membrane. In another embodiment roofing patches can be salvaged from excess roofing material from roofing membrane installations. In one embodiment the excess roofing material can be sourced from the roofing membrane of the roof where the patch is presently being installed. In one embodiment the excess material can be sourced from the excess roofing membrane of another roof installation. In one embodiment the roofing patch can comprise a single piece of roofing membrane. In another embodiment the roofing patch can comprise a plurality of pieces of roofing membrane. Roofing patches can comprise any shape, or combination of shapes, that a person ordinarily skilled in the art would recognize to limit openings between the roofing membrane and the underlying structure.

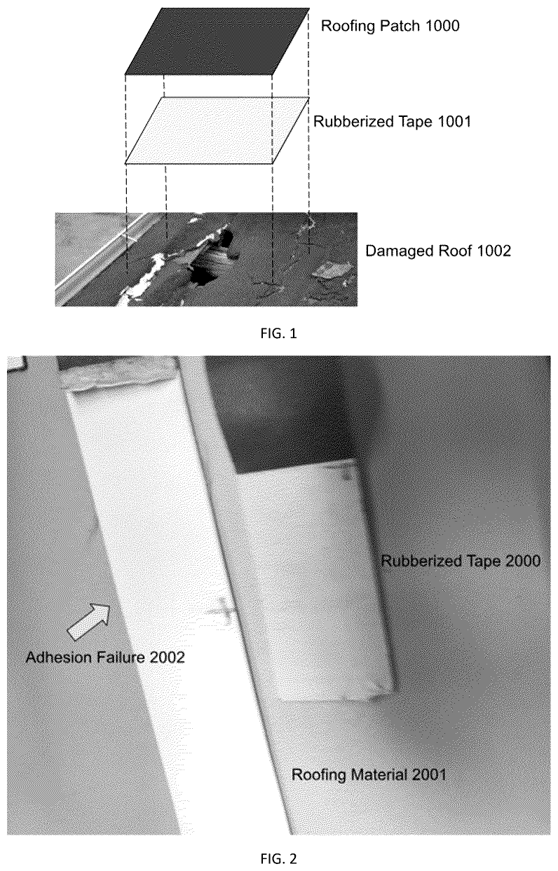

Referring now to the figures of the drawing, FIG. 1 depicts one practice of adhering a roofing patch to a damaged roof. Roofing patch 1000 can be placed over damaged roof 1002 by means of rubberized tape 1001. This allows the roofing patch to be adhered to the existing roofing membrane. The use of rubberized tape with roofing patches facilitates the targeted and economic repair of damaged roofs. However, roofing membranes and roofing patches comprising a PVC/KEE material demonstrate poor adhesion when using rubberized tape. This poor adhesion can compromise the structural integrity of the patch and any intended waterproofing of the repair.

FIG. 2 depicts the results of an adhesion test between rubberized tape and a KEE/PVC roofing membrane using a typical PVC plasticizer primer. Rubberized tape 2000 was placed on roofing material 2001 treated with a typical PVC plasticized primer. When subjected to a peeling force, the rubberized tape lost adhesion to the untreated roofing membrane, and the area where adhesive failure occurred is highlighted as adhesion failure 2002.

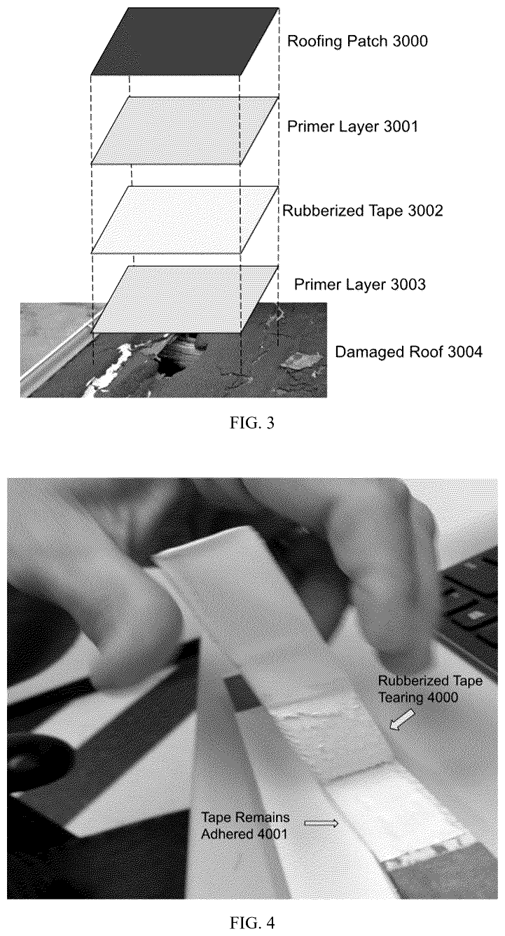

FIG. 3 depicts one embodiment of the present process, wherein the roofing patch 3000 can be first covered in primer layer 3001 to promote good adhesion with rubberized tape 3002. Another primer layer 3003 can be applied to damaged roof 3004 in the area where rubberized tape 3002 will be laid down. The primer layers in this embodiment comprise a plasticized primer comprising phthalate. This process improves adhesion between the roofing membrane, roofing patch, and rubberized tape.

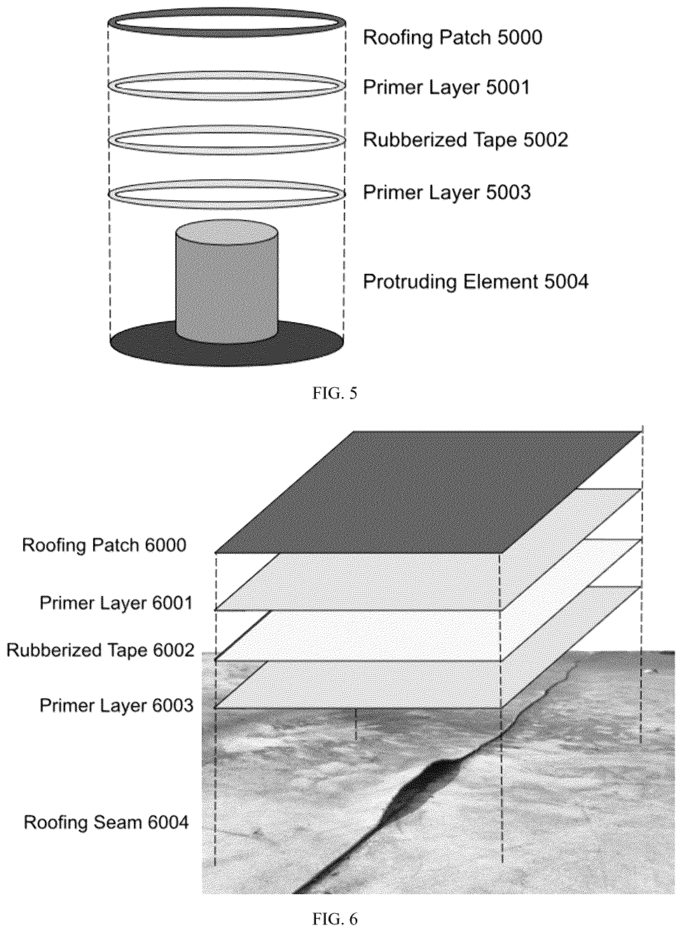

FIG. 4 depicts the results of an adhesion test between rubberized tape and a KEE/PVC roofing membrane treated with a plasticized primer composition comprising phthalate according to one embodiment of the present invention. Surprisingly, the rubberized tape split in half before losing adhesion with the KEE/PVC roofing membrane, demonstrating the extraordinary benefit of the present method in combination with the plasticizer primer comprising phthalate. Thus, the adhesion between the rubberized tape and KEE/PVC roofing membrane treated with the present primer composition not only outlasted and outperformed the example depicted in FIG. 2, but the tape itself. The tearing of the rubberized tape is highlighted as rubberized tape tearing 4000, and the tape remains adhered 4001.

FIG. 5 depicts one embodiment of the present invention, wherein protruding elements on the roof, such as a chimney or exhaust port, can be reinforced using a KEE/PVC roofing patch, which can be adhered using rubberized tape and plasticized primer. Roofing Patch 5000 can be covered in Primer Layer 5001 to promote good adhesion to Rubberized Tape 5002. Primer Layer 5003 can be placed around Protruding Element 5004 in the areas where Rubberized Tape 5002 will contact, and Rubberized Tape 5002, and Roofing Patch 5000 treated with Primer Layer 5001 can be laid around Protruding Element 5004. The primer layers in this embodiment comprise a plasticized primer comprising phthalate.

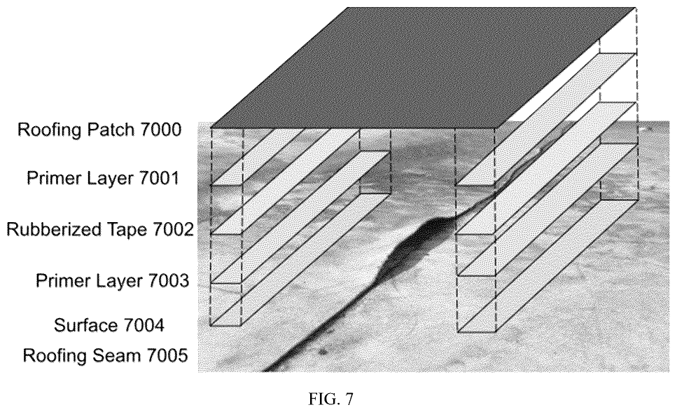

FIG. 6 depicts one embodiment of the present invention, wherein seams between sections of a roofing membrane can be reinforced using a KEE/PVC roofing patch, which can be adhered using a single piece of rubberized tape. Roofing Patch 6000 can be covered in Primer Layer 6001 to promote good adhesion to Rubberized Tape 6002. Primer Layer 6003 can be placed over Roofing Seam 6004 in the areas where Rubberized Tape 6002 will contact. Rubberized Tape 6002, and Roofing Patch 6000 treated with Primer Layer 6001 can be laid over Roofing Seam 6004. The primer layers in this embodiment comprise a plasticized primer comprising phthalate.

FIG. 7 depicts one embodiment of the present invention, wherein seams between sections of a roofing membrane can be reinforced using a KEE/PVC roofing patch, which can be adhered using a plurality of pieces of rubberized tape. Roofing Patch 7000 can be treated along the edges with Primer Layer 6001 to promote good adhesion to Rubberized Tape 7002. Primer Layer 7003 can be placed to either side of Roofing Seam 7005 on Surface 7004, the area of the existing roofing membrane where Rubberized Tape 7002 will contact. Rubberized Tape 7002, and Roofing Patch 7000 treated along its edge with Primer Layer 7001 can be laid over Roofing Seam 7005. This embodiment conserves plasticizer primer and rubberized tape and provides an economic option for roofing membrane seam reinforcement or repair. The primer layers in this embodiment comprise a plasticizer primer comprising phthalate.

The present process, with its use of a plasticizer primer comprising a phthalate, thereby offers improved adhesion between a KEE/PVC roofing membrane and rubberized tape.

As used in this disclosure the word “comprises” or “comprising” is intended as an open-ended transition meaning the inclusion of the named elements, but not necessarily excluding other unnamed elements. The phrase “consists essentially of” or “consisting essentially of” is intended to mean the exclusion of other elements of any essential significance to the composition. The phrase “consisting of” or “consists of” is intended as a transition meaning the exclusion of all but the recited elements except for only minor traces of impurities.

As those skilled in the art will appreciate, numerous modifications and variations of the present invention are possible considering these teachings, and all such are contemplated hereby. For example, in addition to the embodiments described herein, the present invention contemplates and claims those inventions resulting from the combination of features of the invention cited herein and those of the cited prior art references which complement the features of the present invention. Similarly, it will be appreciated that any described material, feature, or article may be used in combination with any other material, feature, or article, and such combinations are considered within the scope of this invention.

All of the publications cited in this disclosure are incorporated by reference herein in their entireties for all purposes.

What is claimed is:

1. A process for providing adhesion between a ketone ethylene ether (KEE) and liquid plasticizer polyvinyl chloride (PVC) roofing membrane and rubberized tape comprising:
a) preparing a PVC plasticizer primer comprising a phthalate;
b) coating a KEE/PVC roofing membrane patch or a portion of a KEE/PVC roofing membrane with said plasticized primer; and
c) adhering rubberized tape to the coated area of the KEE/PVC roofing membrane or patch.

2. The process of claim 1, wherein the phthalate is selected from a group consisting of diisodecyl phthalate (DIDP), diisononyl phthalate (DINP), dinoctyl phthalate (DNOP), and diundecyl phthalate (DUP).

3. The plasticizer primer of claim 1, wherein the concentration of phthalate within the primer is in the range of from about 0.5 to 20 vol %

4. The plasticizer primer of claim 1, wherein the concentration of phthalate within the primer is in the range of from about 5 to 15 vol %

5. The plasticizer primer of claim 1, wherein the concentration of phthalate within the primer is in the range of from about 7 to 13 vol %

6. The process of claim 1, wherein the concentration of KEE within the KEE/PVC roofing membrane is in the range of from about 10 to 30 vol %.

7. A process for repairing a damaged KEE/PVC roofing membrane using a KEE/PVC roofing patch and rubberized tape comprising:
a) preparing a plasticized primer comprising phthalate;
b) identifying a damaged area of a KEE/PVC roofing membrane;
c) coating an area around said damaged area of the KEE/PVC roofing membrane with said plasticized primer;
d) adhering rubberized tape to said coated area;
e) sourcing a KEE/PVC roofing patch large enough to cover said coated area of the KEE/PVC roofing membrane;
f) coating said KEE/PVC roofing patch with said plasticized primer; and
g) laying said KEE/PVC roofing patch over said coated area such that that the KEE/PVC roofing patch fully contacts said rubberized tape and covers the said coated area.

8. The process of claim 7, wherein the phthalate is selected from a group consisting of diisodecyl phthalate (DIDP), diisononyl phthalate (DINP), dinoctyl phthalate (DNOP), and diundecyl phthalate (DUP).

9. The plasticizer primer of claim 7, wherein the concentration of phthalate within the primer is in the range of from about 0.5 to 20 vol %

10. The plasticizer primer of claim 7, wherein the concentration of phthalate within the primer is in the range of from about 5 to 15 vol %

11. The plasticizer primer of claim 7, wherein the concentration of phthalate within the primer is in the range of from about 7 to 13 vol %

12. The process of claim 7, wherein the concentration of KEE within the KEE/PVC roofing patch is in the range of from about 10 to 30 vol %.

13. The process of claim 7, wherein the KEE/PVC roofing patch is sourced from a fresh roll of KEE/PVC roofing membrane.

14. The process of claim 7, wherein the KEE/PVC roofing patch is sourced from KEE/PVC roofing membrane scraps.

15. The process of claim 7, wherein the KEE/PVC roofing patch is one large piece.

16. The process of claim 7, wherein the KEE/PVC roofing patch is a plurality of pieces.

17. A process for reinforcing an area around an element protruding through a KEE/PVC roofing membrane using a KEE/PVC roofing patch and rubberized tape comprising:
a) preparing a plasticizer primer comprising a phthalate;
b) identifying an element protruding though a KEE/PVC roofing membrane;
c) coating an area around said protruding element with said plasticized primer;
d) adhering rubberized tape to said coated area;
e) sourcing a KEE/PVC roofing patch large enough to cover said coated area of the KEE/PVC roofing membrane;
f) coating said KEE/PVC roofing patch with said plasticized primer; and
g) laying said KEE/PVC roofing patch over said coated area such that that the KEE/PVC roofing patch fully contacts said rubberized tape and covers the said coated area.

18. The process of claim 17, wherein the phthalate is selected from a group consisting of diisodecyl phthalate (DIDP), diisononyl phthalate (DINP), dinoctyl phthalate (DNOP), and diundecyl phthalate (DUP).

19. The plasticizer primer of claim 17, wherein the concentration of phthalate within the primer is in the range of from about 0.5 to 20 vol %.

20. The plasticizer primer of claim 17, wherein the concentration of phthalate within the primer is in the range of from about 5 to 15 vol %.

21. The plasticizer primer of claim 17, wherein the concentration of phthalate within the primer is in the range of from about 7 to 13 vol %.

22. The process of claim 17, wherein the concentration of KEE within the KEE/PVC roofing patch is in the range of from about 10 to 30 vol %.

23. The process of claim 17, wherein the KEE/PVC roofing patch is sourced from a fresh roll of KEE/PVC roofing membrane.

24. The process of claim 17, wherein the KEE/PVC roofing patch is sourced from KEE/PVC roofing membrane scraps.

25. The process of claim 17, wherein the KEE/PVC roofing patch is one large piece.

26. The process of claim 17, wherein the KEE/PVC roofing patch is a plurality of pieces.

27. A process for reinforcing a seam of a KEE/PVC roofing membrane using a KEE/PVC roofing patch and rubberized tape comprising:
a) preparing a plasticizer primer comprising a phthalate;
b) identifying a seam between KEE/PVC roofing membranes;
c) coating an area around said seam between the KEE/PVC roofing membranes with said plasticized primer;
d) adhering rubberized tape to said coated area around said seam;
e) sourcing a KEE/PVC roofing patch large enough to cover said coated area of the KEE/PVC roofing membrane;
f) coating said KEE/PVC roofing patch with said plasticized primer; and
g) laying said KEE/PVC roofing patch over said coated area such that that the KEE/PVC roofing patch fully contacts said rubberized tape and covers the said coated area.

28. The process of claim 27, wherein the phthalate is selected from a group consisting of diisodecyl phthalate (DIDP), diisononyl phthalate (DINP), dinoctyl phthalate (DNOP), and diundecyl phthalate (DUP).

29. The plasticizer primer of claim 27, wherein the concentration of phthalate within the primer is in the range of from about 0.5 to 20 vol %.

30. The plasticizer primer of claim 27, wherein the concentration of phthalate within the primer is in the range of from about 5 to 15 vol %.

31. The plasticizer primer of claim 27, wherein the concentration of phthalate within the primer is in the range of from about 7 to 13 vol %.

32. The process of claim 27, wherein the concentration of KEE within the KEE/PVC roofing patch is in the range of from about 10 to 30 vol %.

33. The process of claim 27, wherein the KEE/PVC roofing patch is sourced from a fresh roll of KEE/PVC roofing membrane.

34. The process of claim 27, wherein the KEE/PVC roofing patch is sourced from KEE/PVC roofing membrane scraps.

35. The process of claim 27, wherein the KEE/PVC roofing patch is one large piece.

36. The process of claim 27, wherein the KEE/PVC roofing patch is a plurality of pieces.

37. The process of claim 27, wherein the rubberized tape is one large piece.

38. The process of claim 27, wherein the rubberized tape is a plurality of pieces.
